(19) United States
(12) Patent Application Publication
(10) Pub. No.: US 2015/0193009 A1
(43) Pub. Date: Jul. 9, 2015

(54) FOLDABLE CONFIGURATIONS FOR A THUMB TYPING KEYBOARD

(71) Applicants: Sameer Sharma, Santa Clara, CA (US); Gadi Amit, San Francisco, CA (US); Yoshikazu Hoshino, San Francisco, CA (US); Chadwick Harber, San Francisco, CA (US); Daniel Clifton, San Francisco, CA (US); Kenneth Jasinski, San Francisco, CA (US)

(72) Inventors: Sameer Sharma, Santa Clara, CA (US); Gadi Amit, San Francisco, CA (US); Yoshikazu Hoshino, San Francisco, CA (US); Chadwick Harber, San Francisco, CA (US); Daniel Clifton, San Francisco, CA (US); Kenneth Jasinski, San Francisco, CA (US)

(73) Assignee: INTEL CORPORATION, Santa Clara, CA (US)

(21) Appl. No.: 14/126,305

(22) PCT Filed: Jun. 29, 2013
(86) PCT No.: PCT/US2013/048822

§ 371 Date: Dec. 13, 2013

(51) Int. Cl. G06F 3/02

(52) U.S. Cl. CPC G06F 3/0221; G06F 3/0208

(57) ABSTRACT

Particular embodiments described herein provide for an electronic device that could include a circuit board coupled to a plurality of electronic components (which includes any type of components, elements, circuitry, etc.). One particular example implementation of the electronic device may include a first portion that contains a first display; a second portion that further comprises a keyboard and a fold away area; and a hinge, where the hinge couples the first portion and the second portion, and where the fold away area can rotate with respect to the hinge. In certain cases, the fold away area can rotate with respect to the hinge to expose the keyboard for thumb typing.

### TECHNICAL FIELD

Embodiments described herein generally relate to foldable configurations for an electronic device.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified orthographic view illustrating an embodiment of an electronic device, in accordance with one embodiment of the present disclosure;

FIG. 18B is a simplified orthographic view illustrating an embodiment of an electronic device, in accordance with one embodiment of the present disclosure;

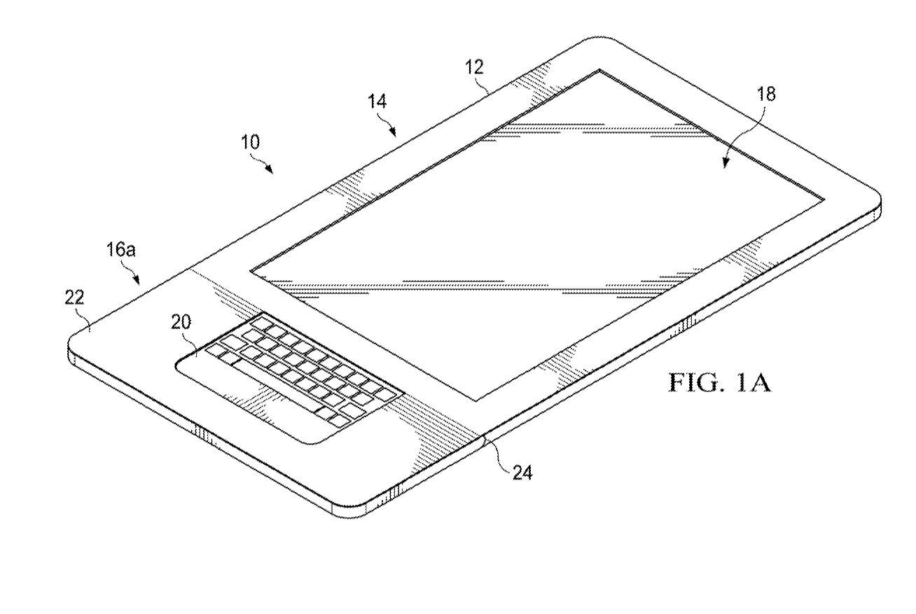

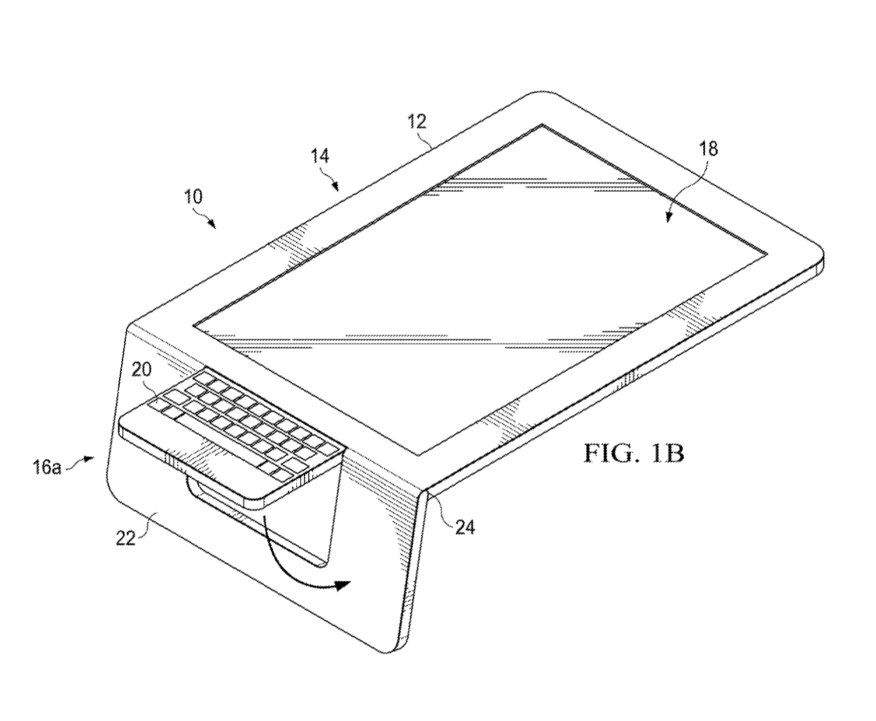

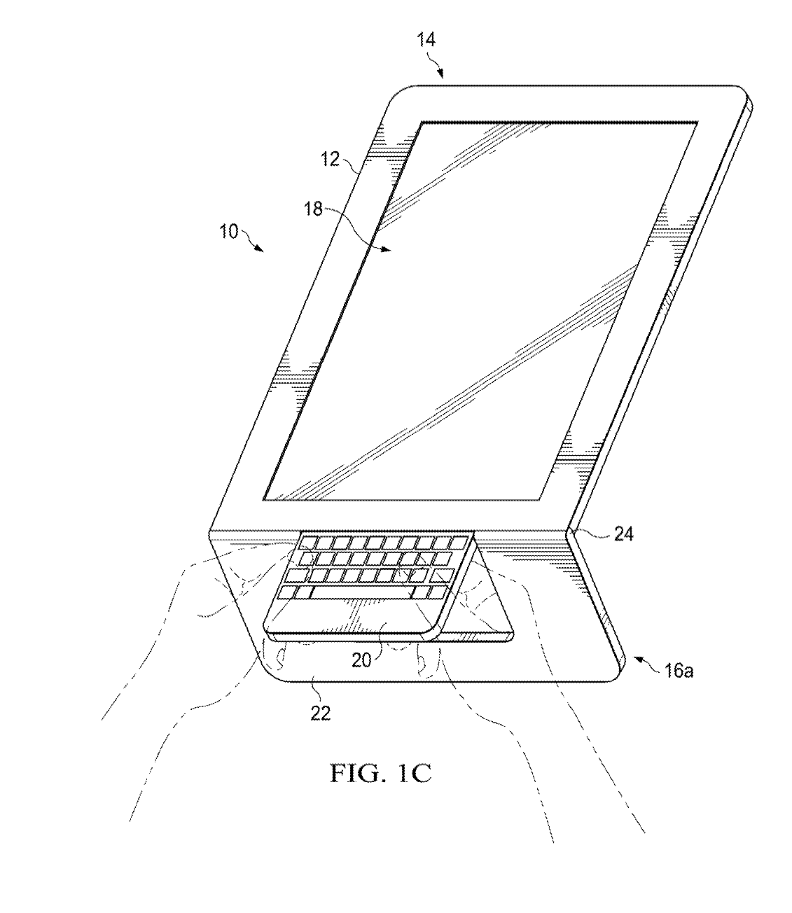

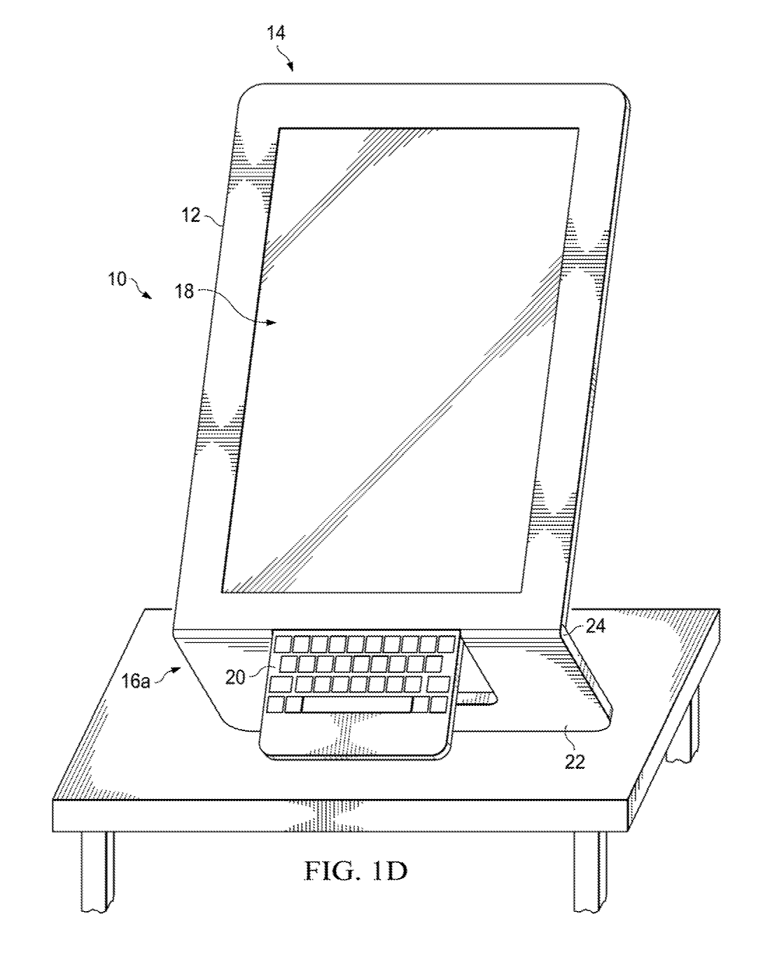

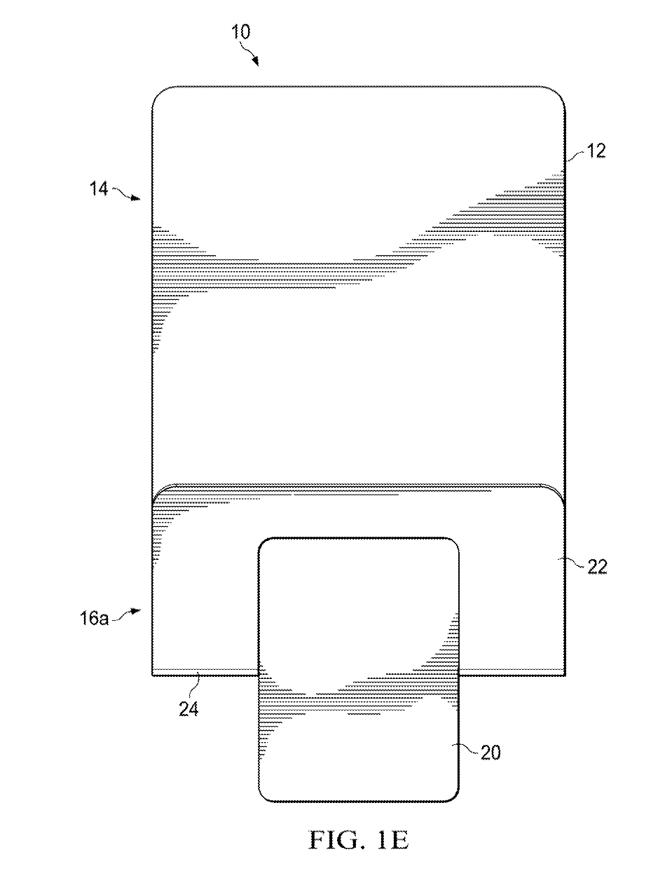

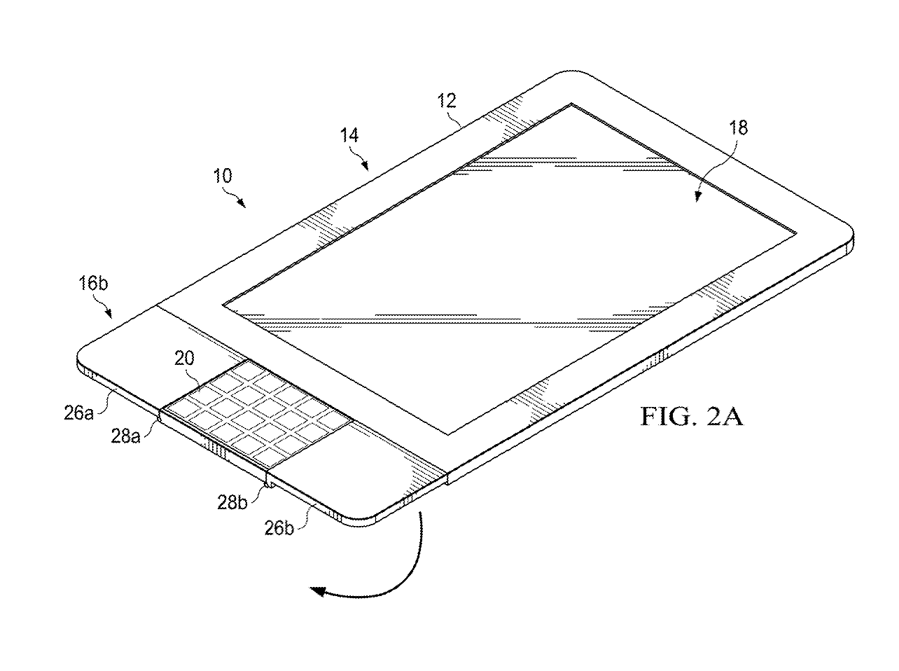

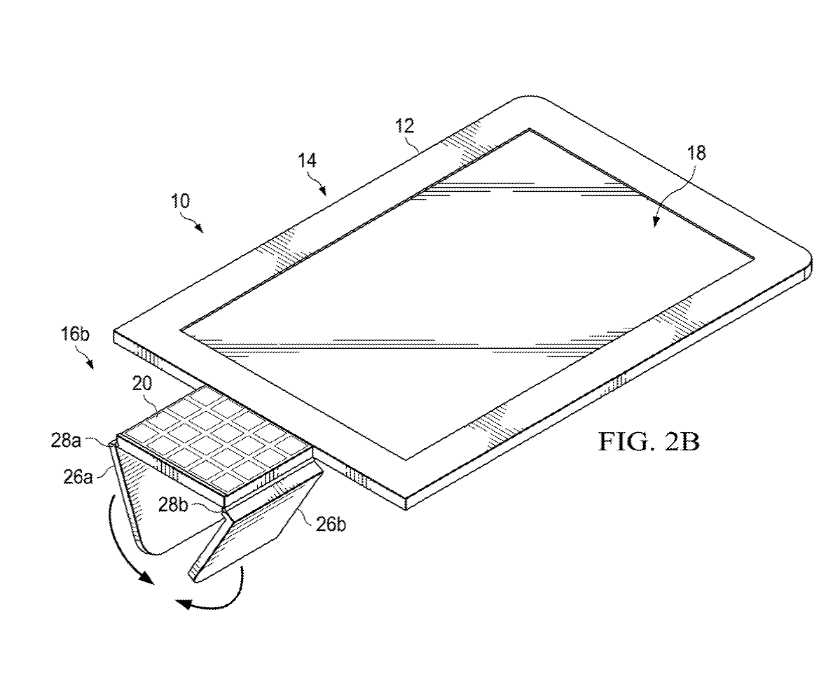

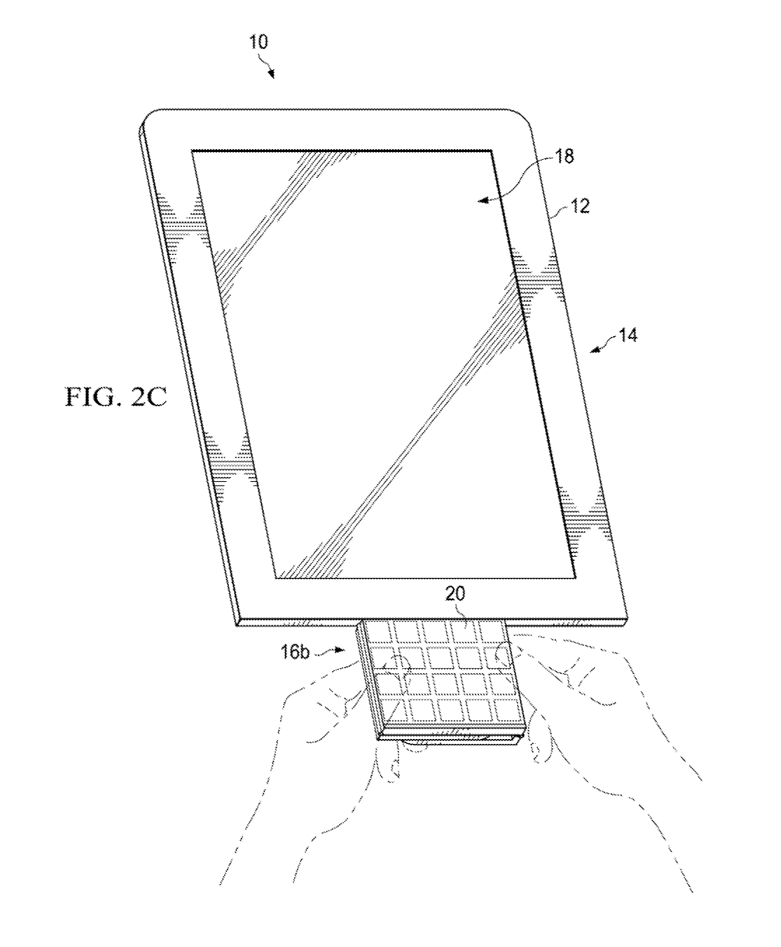

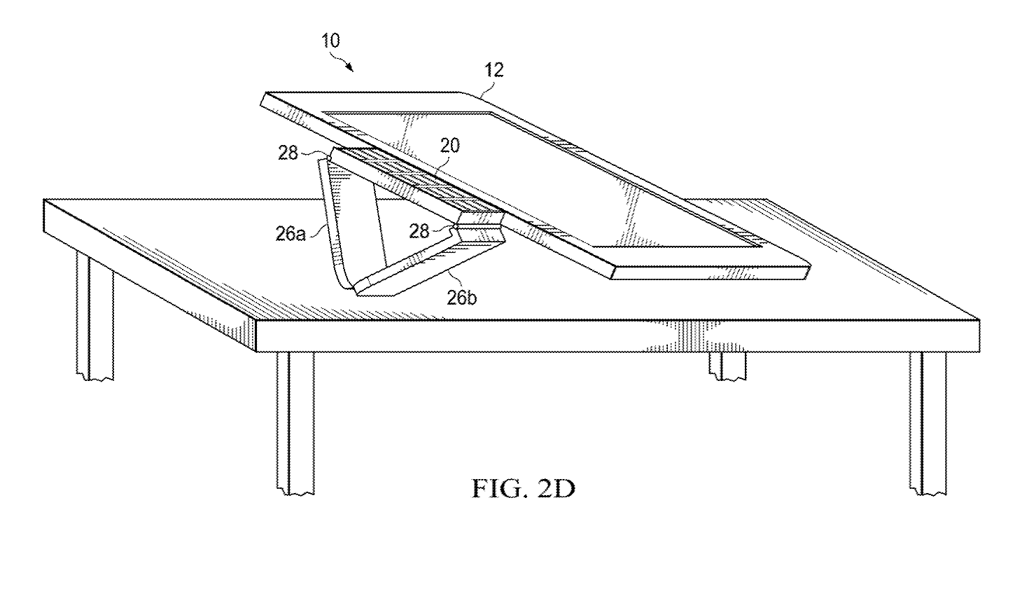

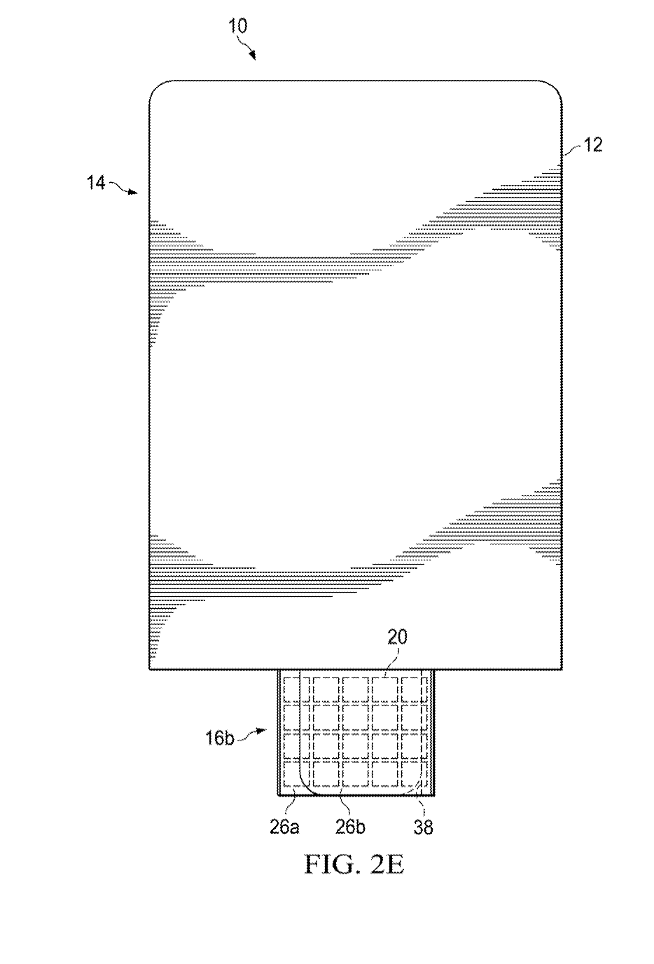

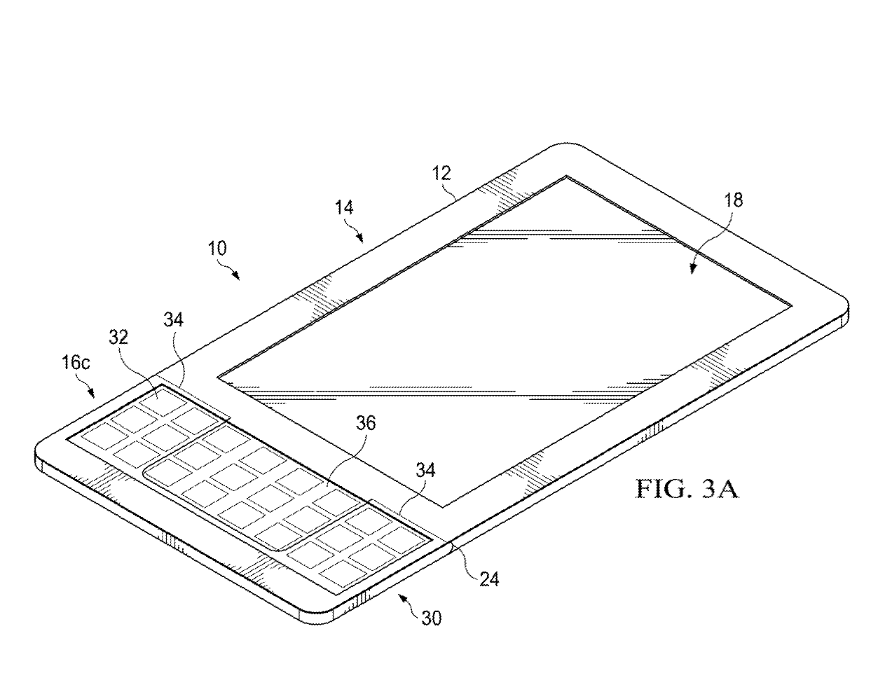

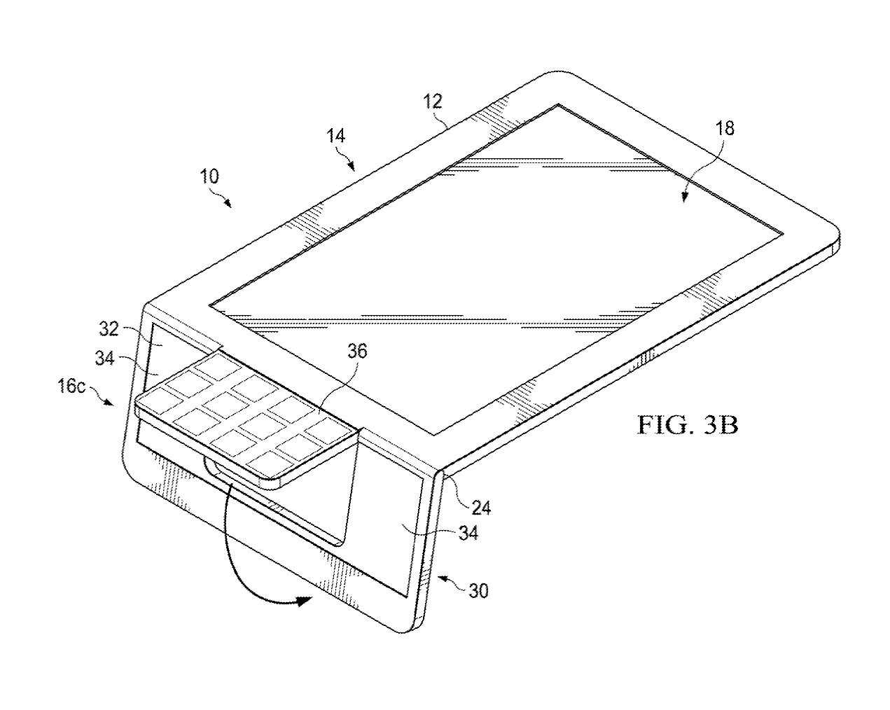

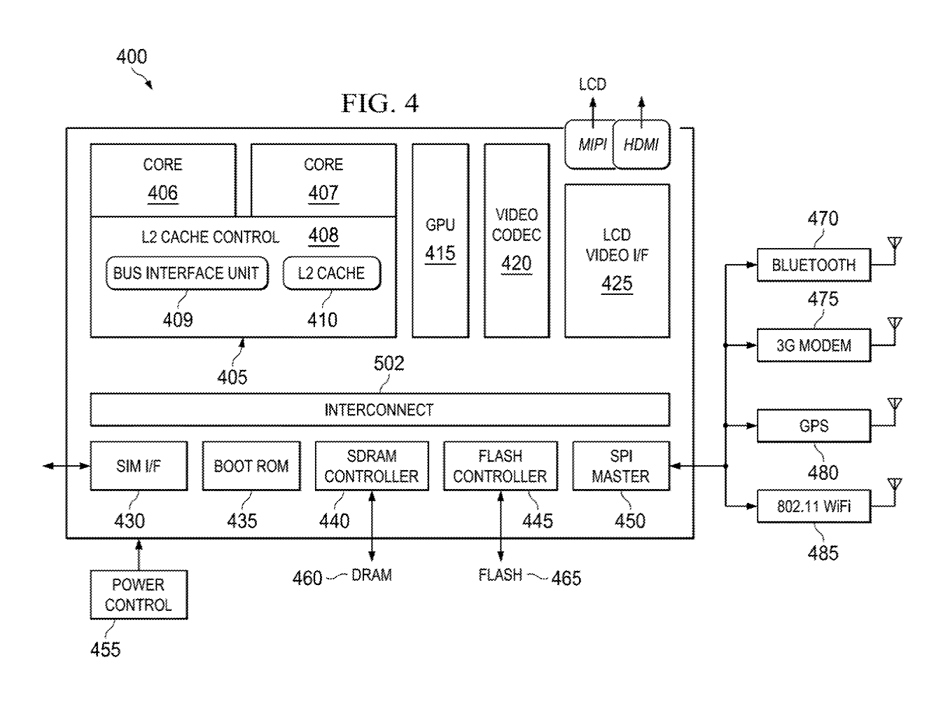

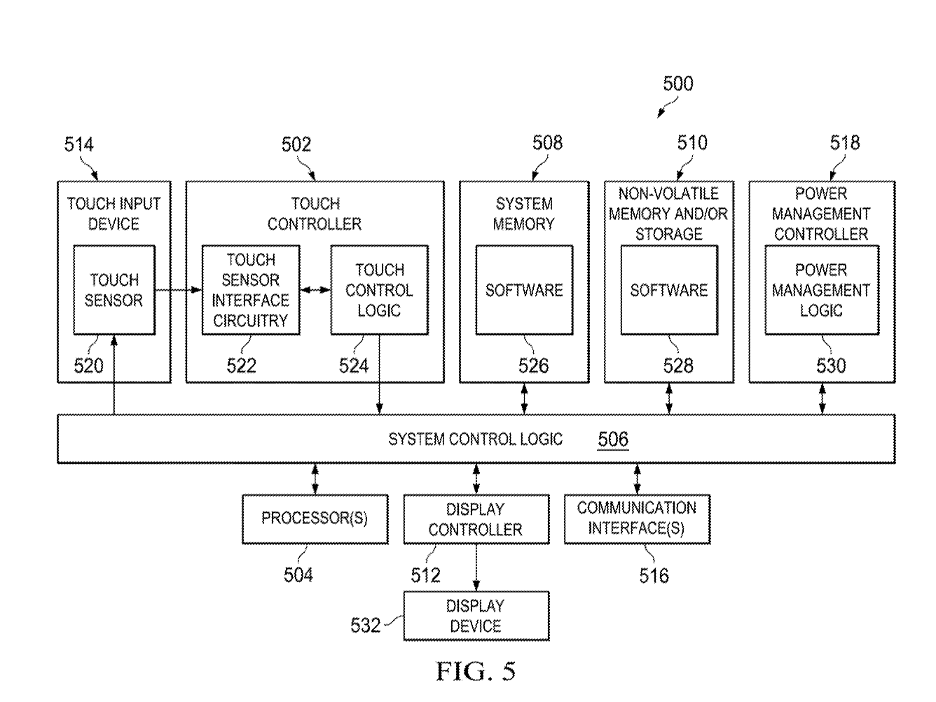

FIG. 1C is a simplified orthographic view illustrating an embodiment of an electronic device, in accordance with one embodiment of the present disclosure;

FIG. 1D is a simplified orthographic view illustrating an embodiment of an electronic device, in accordance with one embodiment of the present disclosure;

FIG. 1E is a simplified block diagram illustrating an embodiment of an electronic device, in accordance with one embodiment of the present disclosure;

FIG. 2A is a simplified orthographic view illustrating an embodiment of an electronic device, in accordance with one embodiment of the present disclosure;

FIG. 2B is a simplified orthographic view illustrating an embodiment of an electronic device, in accordance with one embodiment of the present disclosure;

FIG. 2C is a simplified orthographic view illustrating an embodiment of an electronic device, in accordance with one embodiment of the present disclosure;

FIG. 2D is a simplified orthographic view illustrating an embodiment of an electronic device, in accordance with one embodiment of the present disclosure;

FIG. 2E is a simplified block diagram illustrating an embodiment of an electronic device, in accordance with one embodiment of the present disclosure;

FIG. 3A is a simplified orthographic view illustrating an embodiment of an electronic device, in accordance with one embodiment of the present disclosure;

FIG. 3B is a simplified orthographic view illustrating an embodiment of an electronic device, in accordance with one embodiment of the present disclosure;

FIG. 4 is a simplified block diagram associated with an example ARM ecosystem system on chip (SOC) of the present disclosure; and

FIG. 5 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

The following detailed description sets forth example embodiments of apparatuses, methods, and systems relating to thumb typing configurations for an electronic device. Features such as structure(s), function(s), and/or characteristic(s), for example, are described with reference to one embodiment as a matter of convenience; various embodiments may be implemented with any suitable one or more of the described features.

FIG. 1A is a simplified orthographic view illustrating an embodiment of an electronic device 10 in accordance with one embodiment of the present disclosure. Electronic device 10 may include a main body 12. Main body 12 may include a first portion 14 and a second portion 16a. First portion 14 and second portion 16a may be connected by a hinge 24. Hinge 24 can define an axis of rotation that is shared between first portion 14 and second portion 16a. First portion 14 may include a display 18. Second portion 16a may include a fold away area 22 and a keyboard 20. In one or more embodiments, electronic device 10 may be any suitable electronic device having a display such as a mobile device, a tablet computer and/or a tablet device (e.g., i-Pad), a personal digital assistant (PDA), a smartphone, an audio system, a movie player of any type, a computer docking station, etc. Display 18 may be a liquid crystal display (LCD), organic light-emitting diode (OLED), or some other type of display. Electronic device 10 can contain a battery and various electronics (e.g., wireless module (e.g., Wi-F module, Bluetooth module, etc.) processor, memory, camera, a microphone, speakers, etc.) to allow electronic device to operate as a standalone tablet.

A tablet computer, or simply tablet, is a one-piece mobile computer. A touchscreen responsive to finger (or stylus) gestures or physical buttons such as a keyboard are typically the primary means of control of tablet devices. In some examples, an on-screen, hideable virtual keyboard is generally offered as a way of data input. Though generally self-contained, a tablet computer may be connected to a physical keyboard (or other input device).

Some tablet devices on the market today provide a cumbersome typing experience for the consumer that prefers thumb typing. Tablet devices are typically too wide to comfortably provide thumb-typing capabilities, and as a result, this causes unnecessary and ergonomically uncomfortable twisting of the wrists and stretching of the thumbs to reach the vast expanse of keys. In addition, the weight distribution of the tablet during thumb typing creates undue strain on the wrist and fingers.

In an embodiment, an electrical device can be configured to provide an electronic device with a small keyboard at the bottom of the electronic device for thumb typing and ergonomic thumb-typing capability. The keyboard can include or be imbedded in a push back flap. Such a configuration can provide a place for fingers to rest and allow for an improved grip and a balanced weight distribution of the electronic device. The push back flap can also create a narrow keyboard for improved reach to the keyboard keys.

Turning to FIG. 1B, FIG. 1B is a simplified orthographic view illustrating electronic device 10 in a thumb keyboard configuration in accordance with one embodiment of the present disclosure. As illustrated in FIG. 1B, fold away area 22 has been rotated back on hinge 24. This configuration allows access to keyboard 20 without interference (or relatively little interference) from fold away area 22.

Turning to FIG. 1C, FIG. 1C is a simplified orthographic view illustrating electronic device 10 in a thumb keyboard configuration in accordance with one embodiment of the present disclosure. As illustrated in FIG. 1C, a user can hold keyboard 20 and have access to the keys on keyboard 20 with their thumbs. By rotating fold away area 22 back on hinge 24, a narrow keyboard can be created for an improved reach to the keyboard keys. Such a configuration can provide a place for fingers to rest and allow for an improved grip and a balanced weight distribution of electronic device 10.

Turning to FIG. 1D, FIG. 1D is a simplified orthographic view illustrating electronic device 10 in a thumb keyboard configuration in accordance with one embodiment of the present disclosure. As illustrated in FIG. 1D, keyboard 20 and fold away area 22 may be used as a stand and electronic device 10 can become a stationary display (e.g., movie mode, display mode, etc.). Fold away area 22 may be able to lock into place or may not be able to be folded back or rotate past a certain angle. In this way, keyboard 20 and fold away area 22 may provide a base for electronic device 10 to be self-supporting in an upright position.

Turning to FIG. 1E, FIG. 1E is a block diagram illustrating the back of electronic device 10 in accordance with one embodiment of the present disclosure. As illustrated in FIG. 1E, fold away area 22 has been rotated one hundred and eighty degrees (1800) (or approximately 180°) such that fold away area 22 is in contact with or proximate to the back of first portion 14 of main body 12. The configuration can allow access to keyboard 20 without interference (or relatively little interference) from fold away area 22 when a user interacts with keyboard 20.

Turning to FIG. 2A, FIG. 2A is a simplified orthographic view illustrating an embodiment of an electronic device 10 in accordance with one embodiment of the present disclosure. Electronic device 10 may include main body 12. Main body 12 may include first portion 14 and second portion 16b. First portion 14 may include display 18. Second portion 16b may include fold away flaps 26a and 26b and keyboard 20. Fold away flaps 26a and 26b may be connected to keyboard 20 by hinges 28a and 28b. Hinge 28a can define an axis of rotation that is shared between fold away flap 26a and keyboard 20. Hinge 28b can define an axis of rotation that is shared between fold away flap 26b and keyboard 20.

Turning to FIG. 2B, FIG. 2B is a simplified orthographic view illustrating electronic device 10 in a thumb keyboard configuration in accordance with one embodiment of the present disclosure. As illustrated in FIG. 2B, fold away flaps 26a and 26b have been rotated to a position behind keyboard 20 on hinges 28a and 28b respectively. This configuration allows access to keyboard 20 without interference (or relatively little interference) from fold away flaps 26a and 26b.

Turning to FIG. 2C, FIG. 2C is a simplified orthographic view illustrating electronic device 10 in a thumb keyboard configuration in accordance with one embodiment of the present disclosure. As illustrated in FIG. 2C, a user can hold keyboard 20 and have access to the keys on keyboard 20 with their thumbs. By rotating fold away flaps 26a and 26b (on hinges 28a and 28b respectively) to a position behind keyboard 20, a narrow keyboard can be created for improved reach to the keyboard keys. Such a configuration can provide a place for fingers to rest and allow for an improved grip and a balanced weight distribution of electronic device 10.

Turning to FIG. 2D, FIG. 2D is a simplified orthographic view illustrating electronic device 10 in a thumb keyboard configuration in accordance with one embodiment of the present disclosure. As illustrated in FIG. 2D, keyboard 20 and fold away flaps 26a and 26b may be used as a stand and electronic device 10 can become a stationary display (e.g., movie mode, display mode, etc.). Fold away flaps 26a and 26b may be able to lock into place or may rotate back and rest again each other. In this way, keyboard 20 and fold away flaps 26a and 26b may provide a base for electronic device 10 to be self-supporting in an upright position.

Turning to FIG. 2E, FIG. 2E is a block diagram illustrating the back of electronic device 10 in accordance with one embodiment of the present disclosure. As illustrated in FIG. 3E, fold away flaps 26a and 26b have been rotated 180° (or approximately 180°) such that fold away flaps 26a and 26b are in contact with or proximate to the back of keyboard 20. The configuration can allow access to keyboard 20 without interference (or relatively little interference) from flaps 26a and 26b when a user interacts with keyboard 20. In an embodiment, one fold away flap (e.g., fold away flap 26a) includes a recess 38 or area where the other fold away flap (e.g., fold away flap 26b) can be inserted or nested. This can create a relatively smooth (i.e., substantially) flat profile on the back of keyboard 20, provide a place for fingers to rest, and allow for an improved grip and a balanced weight distribution of electronic device 10.

Turning to FIG. 3A, FIG. 3A is a simplified orthographic view illustrating an embodiment of an electronic device in accordance with one embodiment of the present disclosure. Electronic device 10 may include main body 12. Main body 12 may include first portion 14 and a second portion 16c. First portion 14 and second portion 16c may be connected by a hinge 24. First portion 14 may include a display 18. Second portion 16c may include a digital fold away area 30 and a second display 32. Second display 32 may include a display fold portion 34 and a stationary portion 36. Second display 32 may be a liquid crystal display (LCD), organic light-emitting diode (OLED), or some other type of display. Second display 32 may display a virtual keyboard that allows a user to enter characters or display some other interactive image.

Turning to FIG. 38, FIG. 38 is a simplified orthographic view illustrating an embodiment of an electronic device in accordance with one embodiment of the present disclosure. As illustrated in FIG. 3B, digital fold away area 30 has been rotated back on hinge 24. Once digital fold away area 30 has been rotated back on hinge 24, display 32 becomes divided and instead of displaying a divided keyboard, stationary portion 36 may display a virtual keyboard and display fold portion 34 may be blank or display a graphic. The configuration can allow access to the virtual keyboard on stationary portion 36 without interference (or relatively little interference) from digital fold away area 30.

FIG. 4 is a simplified block diagram associated with an example ARM ecosystem SOC 400 of the present disclosure. At least one example implementation of the present disclosure can include any of the thumb typing features discussed herein and an ARM component. For example, the example of FIG. 4 can be associated with any ARM core (e.g., A-9, A-15, etc.). Further, the architecture can be part of any type of navigation system, tablet, smartphone (inclusive of Android™ phones, i-Phones™), i-Pad™, Google Nexus™, Microsoft Surface™, personal computer, server, video processing components, laptop computer (inclusive of any type of notebook), Ultrabook™ system, any type of touch-enabled input device, etc.

In this example of FIG. 4, ARM ecosystem SOC 400 may include multiple cores 406-407, an L2 cache control 408, a bus interface unit 409, an L2 cache 410, a graphics processing unit (GPU) 415, an interconnect 402, a video codec 420, and a liquid crystal display (LCD) I/F 425, which may be associated with mobile industry processor interface (MIPI)/high-definition multimedia interface (HDMI) links that couple to an LDC.

ARM ecosystem SOC 400 may also include a subscriber identity module (SIM) I/F 430, a boot read-only memory (ROM) 435, a synchronous dynamic random access memory (SDRAM) controller 440, a flash controller 445, a serial peripheral interface (SPI) master 450, a suitable power control 455, a dynamic RAM (DRAM) 460, and flash 465. In addition, one or more examples include one or more communication capabilities, interfaces, and features such as instances of Bluetooth™ 470, a 3G modem 475, a global positioning system (GPS) 480, and an 802.11 WiFi 485.

In operation, the example of FIG. 4 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one example, the core processor may implement an out-of-order superscalar pipeline with a coupled low-latency level-2 cache.

FIG. 5 is a simplified block diagram illustrating potential electronics and logic that may be associated with any of the thumb typing operations discussed herein. In at least one example, system 500 can include a touch controller 502, one or more processors 504, system control logic 506 coupled to at least one of processor(s) 504, system memory 508 coupled to system control logic 506, non-volatile memory and/or storage device(s) 510 coupled to system control logic 506, display controller 512 coupled to system control logic 506, display controller 512 coupled to a display device 532, power management controller 518 coupled to system control logic 506, and/or communication interfaces 516 coupled to system control logic 506.

System control logic 506, in at least one example, can include any suitable interface controllers to provide for any suitable interface to at least one processor 504 and/or to any suitable device or component in communication with system control logic 506. System control logic 506, in at least one example, can include one or more memory controllers to provide an interface to system memory 508. System memory 508 may be used to load and store data and/or instructions, for example, for system 500. System memory 508, in at least one example, can include any suitable volatile memory, such as suitable dynamic random access memory (DRAM) for example. System control logic 506, in at least one example, can include one or more I/O controllers to provide an interface to display device 532, touch controller 502, and non-volatile memory and/or storage device(s) 510.

Non-volatile memory and/or storage device(s) 510 may be used to store data and/or instructions, for example within software 528. Non-volatile memory and/or storage device(s) 510 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 518 may include power management logic 530 configured to control various power management and/or power saving functions disclosed herein or any part thereof. In at least one example, power management controller 518 is configured to reduce the power consumption of components or devices of system 500 that may either be operated at reduced power or turned off when the electronic device is in a closed configuration. For example, in at least one example, when the electronic device is in a closed configuration, power management controller 518 performs one or more of the following: power down the unused portion of the display and/or any backlight associated therewith; allow one or more of processor(s) 504 to go to a lower power state if less computing power is required in the closed configuration; and shutdown any devices and/or components that are unused when an electronic device is in the closed configuration.

Communications interface(s) 516 may provide an interface for system 500 to communicate over one or more networks and/or with any other suitable device. Communications interface(s) 516 may include any suitable hardware and/or firmware. Communications interface(s) 516, in at least one example, may include, for example, a network adapter, a wireless network adapter, a telephone modem, and/or a wireless modem.

System control logic 506, in at least one example, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one example, at least one processor 504 may be packaged together with logic for one or more controllers of system control logic 506. In at least one example, at least one processor 504 may be packaged together with logic for one or more controllers of system control logic 506 to form a System in Package (SiP). In at least one example, at least one processor 504 may be integrated on the same die with logic for one or more controllers of system control logic 506. For at least one example, at least one processor 504 may be integrated on the same die with logic for one or more controllers of system control logic 506 to form a System on Chip (SoC).

For touch control, touch controller 502 may include touch sensor interface circuitry 522 and touch control logic 524. Touch sensor interface circuitry 522 may be coupled to detect touch input over a first touch surface layer and a second touch surface layer of a display (i.e., display device 532). Touch sensor interface circuitry 522 may include any suitable circuitry that may depend, for example, at least in part on the touch-sensitive technology used for a touch input device. Touch sensor interface circuitry 522, in one example, may support any suitable multi-touch technology. Touch sensor interface circuitry 522, in at least one example, can include any suitable circuitry to convert analog signals corresponding to a first touch surface layer and a second surface layer into any suitable digital touch input data. Suitable digital touch input data, for at least one example, may include, for example, touch location or coordinate data.

Touch control logic 524 may be coupled to help control touch sensor interface circuitry 522 in any suitable manner to detect touch input over a first touch surface layer and a second touch surface layer. Touch control logic 524, for at least one example, may also be coupled to output in any suitable manner digital touch input data corresponding to touch input detected by touch sensor interface circuitry 522. Touch control logic 524 may be implemented using any suitable logic, including any suitable hardware, firmware, and/or software logic (e.g., non-transitory tangible media), that may depend, for example, at least in part on the circuitry used for touch sensor interface circuitry 522. Touch control logic 524, for at least one example, may support any suitable multi-touch technology.

Touch control logic 524 may be coupled to output digital touch input data to system control logic 506 and/or at least one processor 504 for processing. At least one processor 504, for at least one example, may execute any suitable software to process digital touch input data output from touch control logic 524. Suitable software may include, for example, any suitable driver software and/or any suitable application software. As illustrated in FIG. 5, system memory 508 may store suitable software 526 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that a number of operations have been described as being executed concurrently with, or in parallel to, one or more additional operations. However, the timing of these operations may be altered considerably. The preceding operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, protocols, and relationships outlined herein (e.g., specific commands, timing intervals, supporting ancillary components, etc.) have only been offered for purposes of example and teaching only. Each of these data may be varied considerably without departing from the spirit of the present disclosure, or the scope of the appended claims. The specifications apply to many varying and non-limiting examples and, accordingly, they should be construed as such. In the foregoing description, examples have been described. Various modifications and changes may be made to such examples without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Example Embodiment Implementations

One particular example implementation of an electronic device may include activities associated with rotating a fold away area (or fold away areas) to expose a keyboard for thumb typing (where ‘thumb typing’ can include any activity in which the thumb could be used for pressing keys on a keyboard). In another example, the electronic device may include a first portion that includes a first display, a second portion that includes a keyboard and a fold away area (e.g., any area that can be recessed, moved back, put away, made less prominent, etc.), and a hinge that couples the first portion and the second portion. The fold away area can rotate with respect to the hinge to expose the keyboard for thumb typing. In another example, the electronic device may include a first fold away area that can rotate on a first hinge and a second fold away area that can rotate on a second hinge to expose a keyboard for thumb typing.

In another example implementation, a system is provided that includes means for rotating (e.g., via a hinge, which encompasses any type of a pivot, an axis, a coupling, a connector, etc.) a first fold away area of an electronic device. The example implementation may also include means for exposing (e.g., by removing, taking away, making at least one portion more prominent, etc.) a keyboard of the electronic device for thumb typing, and means for providing a stand for the electronic device.

### Other Notes and Examples

Example A1 is an electronic device that includes a first portion that contains a first display; a second portion that includes a keyboard and a fold away area; and a hinge, where the hinge couples the first portion and the second portion, and where the fold away area can rotate with respect to the hinge. In Example A2, the subject matter of Example A1 may optionally have the fold away area can rotate with respect to the hinge to expose the keyboard for thumb typing.

In Example A3, the subject matter of any of the preceding ‘A’ Examples can optionally have the fold away area rotate up to approximately one hundred and eighty degrees with respect to the hinge such that the fold away area can rotate proximate to the first portion. The fold away area could also rotate with respect to the hinge to provide a stand for the electronic device.

In Example A4, the subject matter of any of the preceding ‘A’ Examples can optionally the keyboard being a virtual keyboard. In Example A5, the subject matter of any of the preceding ‘A’ Examples can optionally include a portion of the fold away area including a portion of the virtual keyboard prior to the fold away area being rotated with respect to the hinge.

Example AA1 can include an electronic device that includes a first portion that contains a first display; and a second portion that contains a keyboard, a first hinge, a second hinge, a first fold away area, and a second fold away area, where the first hinge couples the first fold away area to the keyboard and the second hinge couples the second fold away area to the keyboard. In Example AA2, the subject matter of any of the preceding ‘A’ Examples can optionally have the first fold away area rotate on the first hinge and the second fold away area can rotate on the second hinge to expose the keyboard for thumb typing.

In Example AA3, the subject matter of any of the preceding ‘A’ Examples can optionally have the first fold away area can rotate up to approximately one hundred and eighty degrees to a back portion of the keyboard on the first hinge and the second fold away area can rotate up to approximately one hundred and eighty degrees to the back portion of the keyboard on the second hinge. In Example AA4, the subject matter of any of the preceding ‘A’ Examples can optionally have the first fold away area include a recess such that the second fold away area can nest in the recess and create a substantially flat profile. In Example AA5, the subject matter of any of the preceding ‘A’ Examples can optionally have the first fold away area and the second fold away area rotate to provide a stand for the electronic device.

Example M1 is a method that includes rotating a first fold away area with respect to a first hinge that is coupled to an electronic device; exposing a keyboard of the electronic device for thumb typing; and providing a stand for the electronic device using at least a portion of the first fold away area. In Example M2, the subject matter of any of the preceding ‘M’ Examples can optionally have the keyboard and the first fold away area being included in a second portion of the electronic device, and where the hinge couples a first portion of the electronic device to the second portion, and where the first portion includes a display.

In Example M3, the subject matter of any of the preceding ‘M’ Examples can optionally have the first fold away area rotate up to approximately one hundred and eighty degrees with respect to the hinge such that the fold away area can rotate proximate to the first portion. In Example M4, the subject matter of any of the preceding ‘M’ Examples can optionally have the keyboard be a virtual keyboard. In Example MS, the subject matter of any of the preceding ‘M’ Examples can optionally have the first fold away area rotate to provide the stand for the electronic device that includes the first fold away area, the keyboard, and a display.

In Example M6, the subject matter of any of the preceding ‘M’ Examples can optionally include rotating a second fold away area on a second hinge to expose the keyboard for thumb typing, where the first hinge couples the first fold away area to the keyboard and the second hinge couples the second fold away area to the keyboard. In Example M7, the subject matter of any of the preceding ‘M’ Examples can optionally have the first fold away area include a recess such that the second fold away area can nest in the recess and create a substantially flat profile.

An example system S1 can include means for rotating a first fold away area of an electronic device; means for exposing a keyboard of the electronic device for thumb typing; and means for providing a stand for the electronic device.

Example X1 is a machine-readable storage medium including machine-readable instructions, when executed, to implement a method or realize an apparatus as in any one of the Examples A1-A5, AA1-AA5, M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions, that when executed cause the apparatus to perform any of the Example methods M1-M7.

1-21. (canceled)

22. An electronic device, comprising:
a first portion that contains a first display;
a second portion that includes a keyboard and a fold away area; and
a hinge, wherein the hinge couples the first portion and the second portion, and wherein the fold away area can rotate with respect to the hinge.

23. The electronic device of claim 22, wherein the fold away area can rotate with respect to the hinge to expose the keyboard for thumb typing.

24. The electronic device of claim 22, wherein the fold away area can rotate up to approximately one hundred and eighty degrees with respect to the hinge such that the fold away area can rotate proximate to the first portion.

25. The electronic device of claim 22, wherein the fold away area can rotate with respect to the hinge to provide a stand for the electronic device.

26. The electronic device of claim 22, wherein the keyboard is a virtual keyboard.

27. The electronic device of claim 26, wherein a portion of the fold away area includes a portion of the virtual keyboard prior to the fold away area being rotated with respect to the hinge.

28. An electronic device, comprising:
a first portion that contains a first display; and
a second portion that contains a keyboard, a first hinge, a second hinge, a first fold away area, and a second fold away area, wherein the first hinge couples the first fold away area to the keyboard and the second hinge couples the second fold away area to the keyboard.

29. The electronic device of claim 28, wherein the first fold away area can rotate on the first hinge and the second fold away area can rotate on the second hinge to expose the keyboard for thumb typing.

30. The electronic device of claim 28, wherein the first fold away area can rotate up to approximately one hundred and eighty degrees to a back portion of the keyboard on the first hinge and the second fold away area can rotate up to approximately one hundred and eighty degrees to the back portion of the keyboard on the second hinge.

31. The electronic device of claim 28, wherein the first fold away area includes a recess such that the second fold away area can nest in the recess and create a substantially flat profile.

32. The electronic device of claim 28, wherein the first fold away area and the second fold away area can rotate to provide a stand for the electronic device.

33. The electronic device of claim 28, wherein the keyboard is a virtual keyboard.

34. The electronic device of claim 33, wherein a portion of the fold away area includes a portion of the virtual keyboard prior to the fold away area being rotated with respect to the hinge.

35. A method, comprising:
rotating a first fold away area with respect to a first hinge that is coupled to an electronic device;
exposing a keyboard of the electronic device for thumb typing; and
providing a stand for the electronic device using at least a portion of the first fold away area.

36. The method of claim 35, wherein the keyboard and the first fold away area are included in a second portion of the electronic device, and wherein the hinge couples a first portion of the electronic device to the second portion, and wherein the first portion includes a display.

37. The method of claim 36, wherein the first fold away area can rotate up to approximately one hundred and eighty degrees with respect to the hinge such that the fold away area can rotate proximate to the first portion.

38. The method of claim 35, wherein the keyboard is a virtual keyboard.

39. The method of claim 35, wherein the first fold away area can rotate to provide the stand for the electronic device that includes the first fold away area, the keyboard, and a display.

40. The method of claim 35, further comprising:
rotating a second fold away area on a second hinge to expose the keyboard for thumb typing, wherein the first hinge couples the first fold away area to the keyboard and the second hinge couples the second fold away area to the keyboard.

41. The method of claim 40, wherein the first fold away area includes a recess such that the second fold away area can nest in the recess and create a substantially flat profile.

42. A system, comprising:
means for rotating a first fold away area of an electronic device;
means for exposing a keyboard of the electronic device for thumb typing; and
means for providing a stand for the electronic device.
